(19) United States
(12) Patent Application Publication
(10) Pub. No.: US 2007/0097943 A1
(43) Pub. Date: May 3, 2007

(54) Method of using the frequency spectrum of a TDD radio system

(75) Inventor: Keld Lange, Otisheim (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/582,340

(22) Filed: Oct. 18, 2006

(30) Foreign Application Priority Data
Nov. 2, 2005 (EP) 05 292 322.4

(51) Int. Cl. H04B 7/216

(52) U.S. Cl. 370/342

(57) ABSTRACT

The invention relates to a method of using a frequency spectrum of a time division duplex (TDD) radio system. Such systems encounter interferences when servicing users with frequencies at the edges of the used frequency spectrum. These interference signals stem from users of other TDD systems being serviced in adjacent frequencies, whereby the other TDD system is not synchronized with the own TDD systems. It is suggested to use an upper guard band 6 and a lower guardband 7 at the edges of the used frequency spectrum F1 to avoid this problem. If interferences are reduced with other measures the guardbands can be reused for a backhauling between the base stations and their core network minimizing hardware requirements for the last mile.

The invention is based on a priority application EP 05 292 322.4 which is hereby incorporated by reference.

### TECHNICAL FIELD

The invention relates to a base station for and a method of using the frequency spectrum of a time division duplex (TDD) radio system. The invention can be used in all wireless communication systems using TDD, such as Wifi systems, Wimax systems, UMTS-TDD systems or DECT systems.

### BACKGROUND OF THE INVENTION

Wireless telecommunication systems, e.g. those offering telephone services, often use TDD. When using this technology for telephone services TDD faces a problem when two devices, e.g. two mobile phones, transmit and receive simultaneously and are connected to different TDD systems, e.g. TDD systems operated by different telecommunication companies. If the two TDD systems are not synchronized with each other the two devices encounter significant interferences if they use adjacent frequencies.

Each TDD system services its users within a certain frequency range. This frequency range is granted by a regulator and might be licensed or unlicensed. To comply with the regulation the operator and the terminals use a multitude of channel filters to make sure that they only transmit signals within the given frequency spectrum. Despite the channel filters the transmitters within a TDD system, in particular the transmitters of the terminals, transmit their signals with an out-of-band power. This out-of-band power is responsible for the above-mentioned interferences.

If the two TDD systems were synchronized the time slots used for the first device would be different from the time slots used for servicing the second device. A synchronization would thus avoid the above-mentioned interferences. However, apart from Korea wireless telecommunication systems using TDD are not synchronized.

### SUMMARY OF THE INVENTION

It is an object of the invention to avoid interferences between two devices being serviced by different TDD systems for the case that the two TDD systems are not synchronized.

Another object of the invention is to use the frequency spectrum of a TDD system more efficiently.

Preferably, the above-mentioned objects are achieved simultaneously.

These objects and other objects are solved by the features of the independent claims. Preferred embodiments of the invention are described by the features of the dependent claims. It should be emphasized that any reference signs in the claims shall not be construed as limiting the scope of the invention.

According to a first aspect a method for using the frequency spectrum of a TDD system is suggested. In a first step an upper guardband at the upper edge of the frequency spectrum, and a lower guardband at the lower edge of the frequency spectrum is defined. In a second step the frequency spectrum is used in such a way that radio links are enabled between the two guardbands, but that emitted signals having frequencies within these guardbands are filtered out. As a consequence, the signal strength of signals having frequencies between the guard bands is higher than for frequencies within the upper or lower guard band. Therefore, users of the TDD system will only be serviced with frequencies between these guardbands, and emissions within the guardbands are kept to a minimum.

Attenuating the unwanted signals in the guardbands is done with filters. In the simplest case the attenuation is achieved inherently by the channel filter. As an example, in a Wimax system covering the frequency range 3.4 GHz-3.6 GHz each channel filter may have a bandwidth of 5 MHz. With the channel filters the TDD system provides the above-mentioned guardbands and would only be responsible for a certain out-of-band power in these guardbands, but not for out-of-band power outside the frequency range granted by the regulator.

Using the guardbands reduces interferences of the above-mentioned type because users will be serviced at frequencies which are too different to experience a significant interference.

In preferred embodiments actions for reducing interferences between a first device serviced by a first TDD system and a second device serviced by a second TDD system are taken, whereby the reduced amount of interference enable the operator to reuse the guardbands for preselected radio links. The preselected radio links might be two TDD radio links which is advantageous when the terminal associated with these links are located nearby. Preselected radio links might also be used for FDD links, e.g. one guardband for transmitting, one guardband for receiving. The preselected radio links might be used to service users in regions with poor reception conditions.

This approach takes into account that future filters, in particular filters used in terminals, will probably have a higher quality. Filters of higher quality will then reduce the out-of-band power more than today. As a consequence the guardbands can then be made smaller or will become superfluous altogether. Even then the interoperability between TDD systems will still be guaranteed.

The measures which can be taken to reduce the interferences within the guardbands may be

Reducing the output power of transmitters, and thus reducing the out-of-band power

Transmitting signals with smaller radiation lobes

As a matter of fact these measures, applied for frequencies within the guardbands, can be taken individually or in combination. All serve to reduce interferences which enable the operator to reuse the guardbands.

In a preferred embodiment the preselected radio link is used for a backhauling between base stations and the core network. Self-backhauling over the air reduces hardware requirements and costs as the last mile between an existing telecommunication network and the base stations for broadband radio systems such as WIMAX are a significant cost factor.

These and other aspects of the invention will be apparent from and elucidated with reference to the embodiments thereafter. It should be noted that the use of reference signs shall not be construed as limiting the scope of the invention.

### BRIEF DESCRIPTION OF THE DRAWINGS

FIG. 1 shows a flowchart illustrating the way in which the method is carried out,

FIG. 2 shows a wireless telecommunication system using the invention.

FIG. 3 shows the frequency ranges associated with operation of the base station of FIG. 2

### DETAILED DESCRIPTION OF PREFERRED EMBODIMENTS

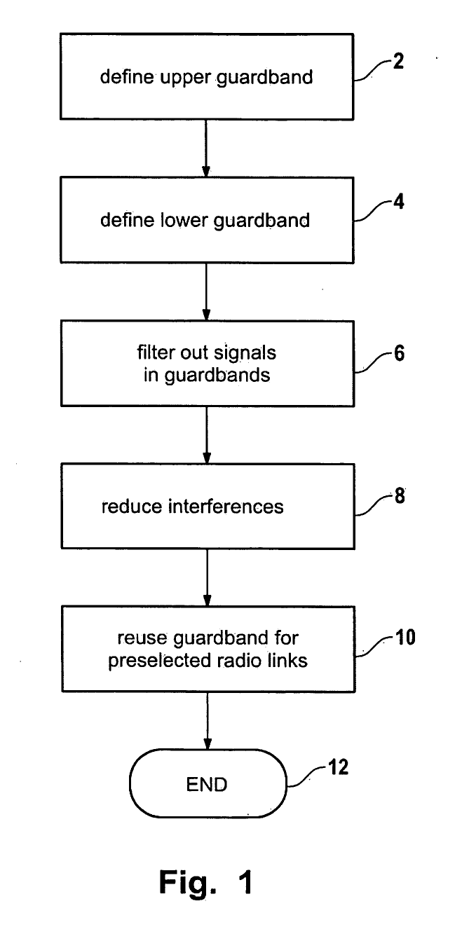

FIG. 1 shows a flowchart illustrating the way in which the method is carried out. In step 2 the upper guardband is defined, and in step 4 the lower guardband.

In operation, signals within the guardbands are filtered out in step 6. This is done by channel filters in the devices of the TDD system, e.g. in base stations or in terminals. As a result, devices of a TDD system using the method according to the invention will face a smaller amount of interference in comparison to users of other TDD systems.

In step 8 action is taken to reduce interferences, e.g. by using a reduced output power, smaller radiation lobes, or receiving signals with increased sensitivity for signals having frequencies within the guardbands. These measures reduce the out-of-band power within the guardbands.

As a consequence, the TDD operator can reuse the guardbands in step 10 for preselected radio links. The guardbands are used for self-backhauling of the TDD system reducing hardware requirements of the last mile which is otherwise based on cable connections. The method then stops with step 12.

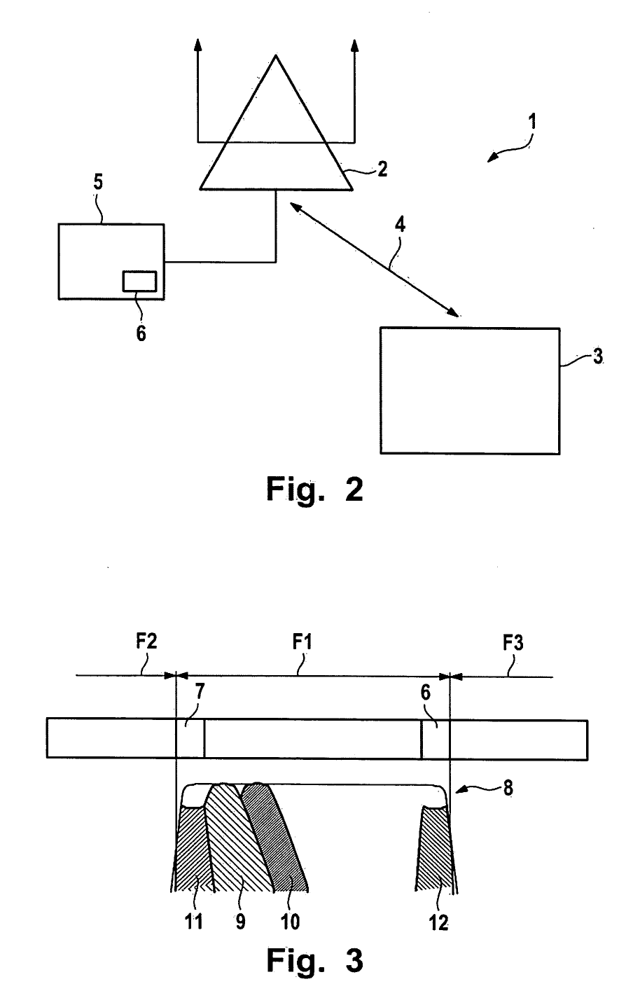

FIG. 2 shows a TDD radio system 1 with a base station 2 connected to a core network 3 by a radio link 4. Associated with the base station 2 is a logic 5 responsible for the transmission and reception of signals over the air interface. The logic 5 comprises a channel filter 5 to provide an upper guardband and a corresponding channel filter (not shown) to provide a lower guardband.

FIG. 3 shows the frequency ranges associated with the operation of the base station 2. The operator of the base station 2 is using a frequency spectrum F1, whereas competitors use frequency spectra F2 and F3. The frequency specra might be granted to them by a regulator. The spectrum F1 has an upper guardband 6 and lower guardband 7. The multitude of channel filters provide a spectrum mask 8. Output spectra 9, 10 of a carrier frequency are located between the guardbands 6, 7. The output spectra 11, 12 of the backhauling links are located in the lower and upper guardband respectively.

### List of Reference Numerals

01 TDD system

02 Base station

03 Core network

04 Logic

05 Filter

06 Upper guardband

07 Lower guardband

08 Spectrum mask

09 Output spectrum of a carrier frequency

10 Output spectrum of a carrier frequency

11 Output spectrum of backhauling link

12 Output spectrum of backhauling link

F1 frequency spectrum

F2 frequency spectrum

F3 frequency spectrum

1. A method with which a time division duplex radio system uses a frequency spectrum, wherein
an upper guardband at the upper edge of the frequency spectrum, and
a lower guardband at the lower edge of the frequency spectrum
are defined, whereby signals having frequencies within these guardbands are transmitted with a signal strength which is smaller than the signal strength of signals having frequencies between the guard bands.

2. The method according to claim 1, wherein signals having frequencies within the upper guardband or within the lower guardband are transmitted with a reduced output power in comparison to signals having frequencies between the guardbands, and that the guardbands are reused for preselected radio links.

3. The method according to claim 1, wherein signals having frequencies within the upper guardband or within the lower guardband are transmitted or received using antennas with smaller radiation lobes in comparison to signals having frequencies between the guardbands, and that the guardbands are reused for preselected radio links.

4. The method according to claim 1, wherein signals having frequencies within the upper guardband or within the lower guardband are received with a higher sensitivity in comparison to signals having frequencies between the guardbands, and that the guardbands are reused for preselected radio links.

5. The method according to claim 1, wherein the preselected radio links are used for a backhauling between a base station and a core network.

6. The method according to claim 1, wherein the preselected radio links are used for providing a radio access in regions having reception conditions below average.

7. A base station of a time division duplex radio system, the base station comprising channel filters for the provison of an upper guard band and of a lower guard band at the edges of a frequency spectrum covered by said base station.

8. The base station according to claim 8, wherein it is adapted to provide WIMAX services.

9. The base station according to claim 8, wherein it is adapted to use the upper guard band and/or the lower guard band for a backhauling with the core network.

10. A time division duplex radio system, comprising a base station according claim 6.

11. A time division duplex radio system, comprising a base station according to claim 7.
